(19) United States
(12) Patent Application Publication
(10) Pub. No.: US 2010/0287102 A1
(43) Pub. Date: Nov. 11, 2010

(54) FACILITATION OF RENEWABLE ENERGY DELIVERY USING FLOATING POWER PURCHASE AGREEMENTS

(76) Inventor: Geoffrey Nicholas Barnard SUTTON, Scottsdale, AZ (US)

Correspondence Address: MICHAEL WINFIELD GOLTRY, 4000 N. CENTRAL AVENUE, SUITE 1220, PHOENIX, AZ, 85012, US

(21) Appl. No.: 12/436,675

(22) Filed: May 6, 2009

(51) Int. Cl. G06Q 30/00; G06Q 10/00

(52) U.S. Cl. 705/80; 705/10; 705/8

(57) ABSTRACT

Various method, system, computer program, and business method embodiments for facilitation of renewable energy delivery using floating power purchase agreements are disclosed. In one embodiment a method for providing renewable energy for the benefit of a plurality of customers, incorporating calculations performed by at least one processor of a data processing computer environment is provided. An estimate of renewable energy provided by a renewable energy cooperative organization over a predetermined time interval is calculated based on data associated with a status of one of the plurality of the customers in the renewable energy cooperative organization. The estimate is electronically incorporated into a floating power purchase agreement (FPPA) negotiated between the renewable energy cooperative organization and an entity. The entity agrees to purchase a flexible remainder amount of the renewable energy pursuant to the FPPA.

### BACKGROUND OF THE INVENTION

1. Field of the Invention

The present invention relates in general to data processing computer environments facilitating delivery of renewable energy to customers, and more particularly to method, system, and business method embodiments for facilitating delivery of renewable energy to customers using floating power purchase agreements.

2. Description of the Related Art

Electricity or power is an essential part of modern life. In residences, in businesses, in institutions and in other locations, consumers use electricity in a variety of ways. Utilities typically supply power to consumers as needed. FIG. 1 illustrates a diagram of a power system of the prior art. As is shown, entities such as electrical utilities deliver power generated by power plants through a network of transmission and distribution lines to a customer. This network is hereinafter referred to as the “power transmission and distribution grid,” “the electric grid,” “the grid” or “power grid.” Numerous publications describe electricity production, demand and costs in great detail.

Renewable energy is a practical and environmentally conscious alternative to traditional electrical production from utilities. One of the more desirable renewable sources is solar power. Solar energy can be harnessed in most developed country locations with solar access. Additionally, solar equipment consumes no fossil fuels and generates no air pollutants. The use of solar power is generally regarded as environmentally safe. Utilities in many States are required (or voluntarily do so) for public policy reasons to credit or buy excess power generated by a consumer.

While solar power provides an attractive alternative to traditional sources of electrical power, a large number of customers, including businesses and residential consumers alike, have been limited in obtaining solar power for their use. For a customer to directly benefit appreciably from the use of solar power, traditionally the customer has had the responsibility to individually finance, install, and maintain solar equipment. While vehicles such as tax credits and other incentives have made it easier for customers to implement such equipment, obstacles remain.

For example, a large number of commercial buildings and residential homes cannot install solar equipment for a variety of reasons, including incorrect roof orientation, lack of usable roof area, prohibitive cost, dead and live load limitations, roofing warranty, shading issues, architectural aesthetic considerations, an inability to use tax vehicles, and so on. Many of these reasons present complicated challenges to the long-term use and enjoyment of solar energy by a particular customer. As a result, the delivery of solar power to such customers is hampered, if not eliminated.

### SUMMARY OF THE INVENTION

In light of the challenges presented above, a need exists for a mechanism whereby the delivery of renewable energy such as solar power is facilitated in such a way that any customer may participate. As the skilled artisan will appreciate, implementation of such a mechanism may benefit by use of modern electronic networking, processing, storage and related technologies provided by data processing computer environments.

Accordingly, in one embodiment, by way of example only, a method for providing renewable energy for the benefit of a plurality of customers, incorporating calculations performed by at least one processor of a data processing computer environment is provided. An estimate of renewable energy provided by a renewable energy cooperative organization over a predetermined time interval is calculated based on data associated with a status of one of the plurality of the customers in the renewable energy cooperative organization. The estimate is electronically incorporated into a floating power purchase agreement (FPPA) negotiated between the renewable energy cooperative organization and an entity. The entity agrees to purchase a flexible amount of the renewable energy pursuant to the FPPA. Various additional system, computer program and business method embodiments are also disclosed and provide related advantages.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict embodiments of the invention and are not therefore to be considered to be limiting of its scope, the invention will be described and explained with additional specificity and detail through the use of the accompanying drawings, in which:

FIG. 1 is a block diagram showing prior art power delivery system;

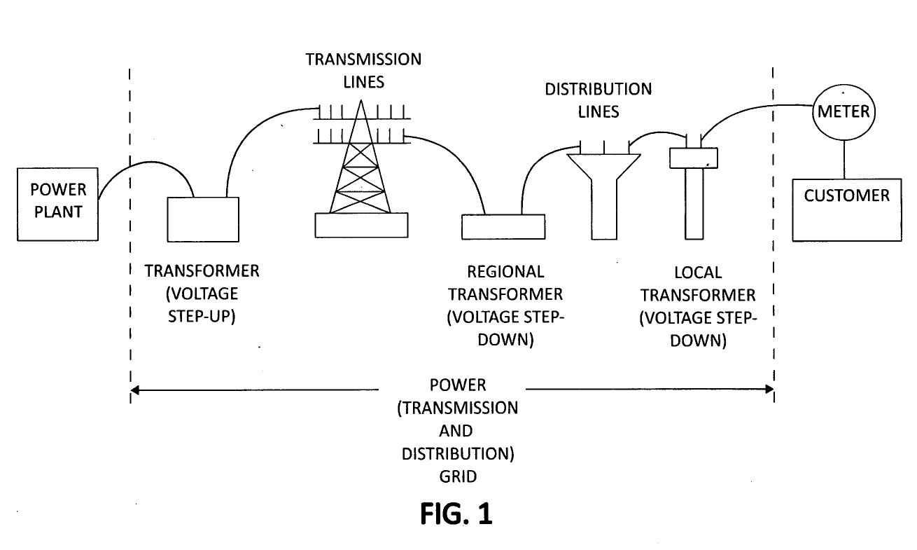

FIG. 2 is a block diagram showing an exemplary embodiment of a data processing computer environment adapted for implementation of a floating power purchase agreement (FPPA);

FIG. 3 is a block diagram showing exemplary functionality of the data processing computer environment previously depicted in FIG. 2 as implemented by a renewable energy cooperative organization;

FIG. 4 is a flow chart diagram of an exemplary method for providing renewable energy to a number of customers including use of a FPPA;

FIG. 5 is a block flow diagram of exemplary relationships between various entities making use of a FPPA to deliver renewable energy;

FIG. 6 is a flow chart diagram of an additional exemplary method for providing renewable energy to a number of customers including use of a FPPA; and

FIG. 7 is a flow chart diagram of an exemplary method for providing renewable energy to a number of customers including use of a FPPA as embodied in a computer program product.

### DETAILED DESCRIPTION OF THE DRAWINGS

The illustrated embodiments of the present invention and claimed subject matter provide for mechanisms to better address the various challenges previously described in providing renewable energy, such as solar power, to customers unable to individually finance, install, and/or maintain renewable energy infrastructure. These embodiments leverage a renewable energy cooperative organization, or “co-op” as is herein described. In some respects, the co-op may operate in similar fashion to other cooperative organizations. For example, the co-op is collectively owned by each of the electrical customers. The skilled artisan will appreciate various aspects of how such an electrical co-op may be organized and implemented.

The illustrated embodiments described below allow for the co-op to negotiate with a participating entity, such as an electrical utility, to flexibly provide for renewable energy according to aspects (such as provisions) of a unique vehicle termed a “floating power purchase agreement” (FPPA) or, in the case of solar renewable energy, a “floating solar service agreement” (FSSA). Throughout the following description, the terminologies floating power purchase agreement and floating solar service agreement, and the terms FPPA and FSSA will be used interchangeably to refer to essentially the same mechanism. The functionality of the FPPA will be further described in detail. Because a variety of input factors must be considered in the context of the FSSA for the FSSA to be effectively administered, the FSSA may be implemented as between various entities using various aspects of a data processing computer environment, as will be described. Through use of economies of scale, use of a co-op as described above implementing one or more FSSA mechanisms may provide a cost-effective means for delivering renewable energy to customers otherwise unable to participate.

A number of States have begun to institute regulatory schemes requiring a certain percentage of electrical power production to be generated from renewable energy. In addition, governmental bodies worldwide have begun to implement so-called “cap and trade” regulatory methodologies. As a result, new and cost-effective techniques are needed to enhance penetration of renewable energy consumption into the marketplace. Use of the renewable energy cooperative organization described above in combination with FPPA/FSSA mechanisms provide unique solutions previously not implemented in the marketplace.

As described previously, various calculations relating to implementation of one or more FSSAs in a co-op setting may be performed in a data processing computer environment. For example, production data obtained in regular intervals, such as daily, weekly, monthly, and yearly data may be computed in the context of one or more FSSAs. The FSSA must be flexible enough to permit entities of differing sizes to enter and exit on an ongoing basis. Accordingly, the FSSA must be able to expand and contract as various participants enter and exit. A variety of additional factors should be considered in regular intervals. These may include such factors as any applicable net metering mechanisms (including dual net metering mechanisms as known to the skilled artisan), loans and loan amortizations, pro-rating of various values, tax considerations such as investment tax credit (ITC) factors, additional costs (fixed and/or variable) and other factors known to the skilled artisan. Each of these functions may need to be considered/calculated together, separately, or in customized components. The data processing environment may assist in taking any or all of these factors into account. Finally, additional changes over time, such as adjustments pursuant to feed-in tariffs, tier pricing, time-of-day net metering programs, and the like, should be considered. The skilled artisan will therefore appreciate that one or more processor devices adapted to carry out calculations relating to these factors in the context of a FPPA may provide assistance.

It should be noted, that for FPPAs, FSSAs, or power purchase agreements known in the art (PPAs) to be legal in some jurisdictions, such mechanisms must possess a so-called ‘buy-out” option. In this regard, computer implemented components may be utilized to make value determinations (e.g., present value or future value) for specific purchase dates. Because there is no constant relating to ownership size and/or duration of a co-op as previously described, reconciliations may need to be ongoing for when absolute buyout occurs as stipulated under relevant jurisdictions.

In addition to the functionality of FSSA mechanisms being described below, various methodologies for implementing such mechanisms in the context of a co-op as between other participating entities will also be described. In one embodiment, a co-op may be formed by a variety of such entities, such as a utility, municipality, company, or group of individuals. A member/owner of the co-op may provide information and other data indicative of his/her membership status as will be further described. The member may pay for, borrow, or otherwise finance their position in the co-op. Regulations as to a total purchase in relation to the member (albeit residential consumer, business consumer, etc.) may be imposed. In one embodiment, the day-to-day operation costs are assessed to the member as a fee in conjunction with other regulations of the co-op.

Funding for the member position may be obtained from a variety of sources, as will be further described. Some examples include, but are not limited to governmental bodies via loan programs or grants, traditional banks, a bank formed by the co-op, an installation company, and other financing sources. A renewable energy installer may be contracted to build renewable energy infrastructure, such as a solar farm including various electrical generating, metering, and delivery equipment as the skilled artisan will appreciate, for the owners/members of the co-op. The installer may or may not be contracted with to perform the daily operation of such a facility.

In a variety of differing scenarios, the renewable energy is flexibly supplied pursuant to the FPPA. Various implementations of these scenarios may include a remote (e.g., offsite from the building address) net metering mechanism, or other mechanisms. The participating entity purchasing the power, such as the utility, may, in one embodiment, then allocate the co-op production to the correct billing address in the proportions as stipulated in the FPPA.

The co-op individual membership/ownership may change month to month, as the skilled artisan will appreciate. Such volatility would normally affect the viability of a renewable energy co-op due to the requirement that all energy generated from the co-op be allocated in some manner. To address this volatility, the FPPA flexibly accommodates changes in membership status. Accordingly, such membership changes may take the form of an increased position, decreased position, or liquidated position as accommodated pursuant to the FPPA. In addition, new customers may assume membership in the co-op, and such new positions are then allocated, again pursuant to the FPPA. The unallocated purchases of renewable energy pursuant to such a new or increased position is be subsequently assigned (as that portion of the FPPA is fulfilled) to the participating entity, in effect “contracting” the FPPA. Similarly, decreased or liquidated positions “expand” the FPPA by creating unallocated portions of the FPPA that were previously allocated. An important aspect of the FPPA is such flexibility to contract when new and increased positions allocate previously unallocated portions of renewable energy, and expand when positions decrease and/or are liquidated. This puts literally life in the renewable energy co-op as portions of the whole expand and contract to meet its needs of full allocation.

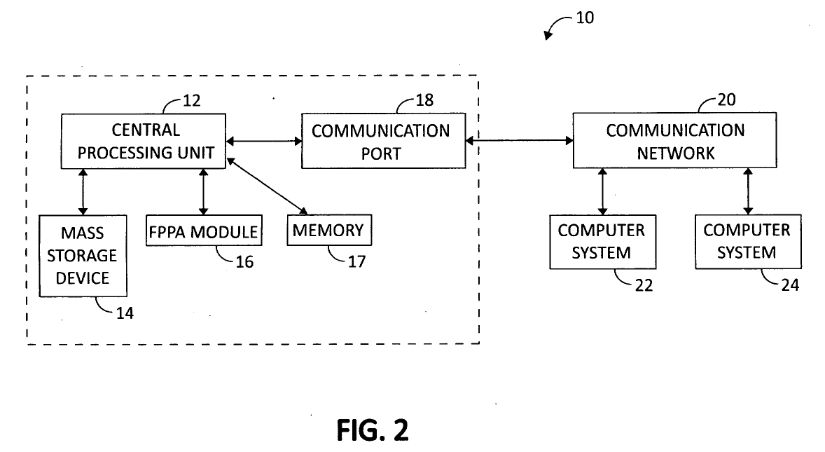

Referring now to FIG. 2, and exemplary data processing computer processing environment 10 is depicted in which various aspects of the present invention and claimed subject matter may be implemented. Environment 10 includes a central processing unit (CPU) 12. CPU 12 is in communication with a mass storage device 14, such as a hard disk drive or redundant array of independent disks (RAID) data storage array. CPU 12 is also in communication with an FPPA module 16, which is adapted for implementing FPPAs as between the co-op and participating entities. Finally, CPU 12 is in communication with memory 17, such as an electrically erasable programmable read only memory (EEPROM) device. As the skilled artisan will appreciate, FPPA module 16 may be adapted, in conjunction with memory 17, mass storage device 14, and CPU 12 to perform various data processing, data storage and data transfer functions.

FPPA module 16 is adapted to be implemented in the context of environment 10 to implement and execute FPPAs as between the co-op and participating entities. Accordingly, FPPA module 16 may, along with CPU 12 and other electronic components in environment 10, receive data from customers (such as enrollment data), provide data to participating entities (such as financial data to a participating financial institution), calculate estimates of renewable energy production (such as that which may be incorporated into a particular FPPA), calculate and otherwise incorporate costs of such production, and the like. To carry out some of this functionality, FPPA module 16, along with CPU 12 and storage and memory devices 14 and 17 are interconnected with a communication port 18 and with a communication network 20 with other computer systems 22 and 24. The skilled artisan will appreciate that such communication networks may include local area networks (LANs), wide area networks (WANs), wireless networks, the world wide web (WWW) and the like, making use of a variety of communications protocols, such as an IEEE 802.11 communications protocol, Ethernet, etc. Computer systems 22 are contemplated in a wide scale, from a mainframe computer system as maintained by a power utility, to a small personal desktop assistant (PDA) device. As will be further illustrated, computer environment 10 may be adapted to maintain communications with a wide variety of participating entities for purposes of implementing FPPA vehicles, and thereby, facilitating generation and delivery of renewable energy.

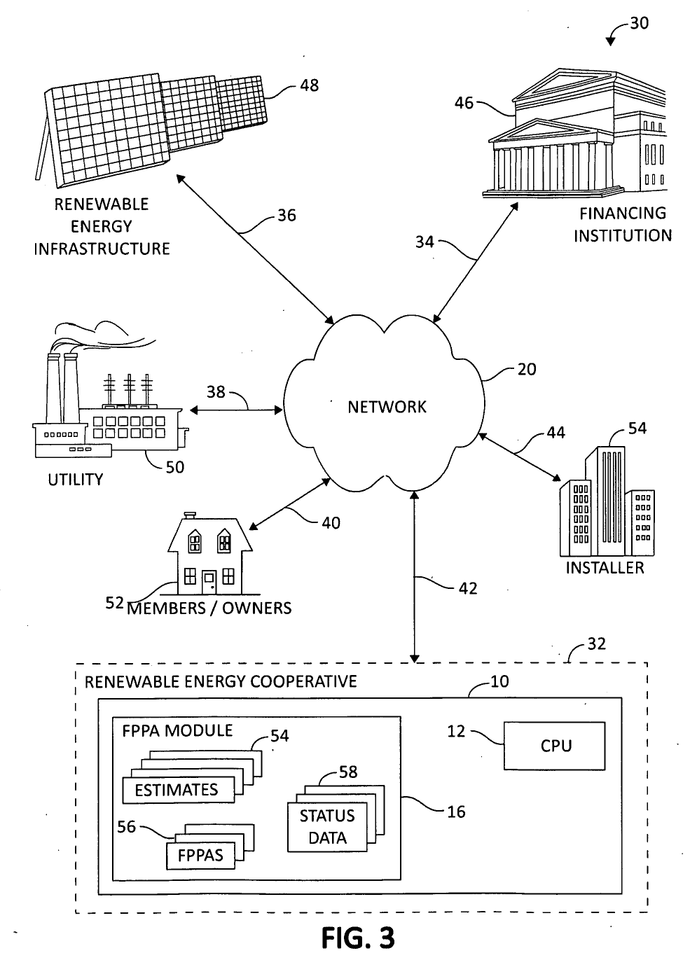

Referring now to FIG. 3, a block diagram showing exemplary functionality of the data processing computer environment previously depicted in FIG. 2 as implemented by a renewable energy cooperative organization is depicted. FIG. 3 depicts a network 30 of participating entities that may leverage a FPPA/FSSA in some way to benefit members/owners of the co-op. As shown, data processing computer environment 10 is maintained by co-op 32. The environment 10 communicates with other participating entities, owner/members (customers) 52 and the renewable energy infrastructure 48 via network 20. Such participating entities include an electrical utility 50, a financing institution 46, and an installer 54. Here, as depicted previously, network 20 may make use of a combination of available technologies to provide for data processing, data movement, and data storage. Co-op utilizes connection 42 to network 20. Customers are connected to network 20 via connection 40. The utility 50 is connected to the network 20 via connection 38. Infrastructure 48 is connected to the network 20 via connection 36. Financing institution 46 is connected to the network via connection 34. Finally, the installer 54 is connected to the network 20 via connection 44. Network 20 allows for data movement between each of the various participating entities thus described.

FPPA module 16 is implemented in environment 10 as shown. FPPA module 16, in combination with other memory devices previously described, implement and maintain one or more FPPAs as between the co-op and participating entities for the benefit of owner/members. FPPA module 16, in conjunction with CPU 12, calculates and maintains various estimates of renewable energy production 54, as well as data indicative of the status of a particular owner/member 52 (status data 58).

As the skilled artisan will appreciate, estimates 54 and status data 58 are representative of a variety of data that may be processed by the FPPA module 16 pursuant to implementation and maintenance of a particular FPPA as between the co-op and one or more participating entities. This variety of data relates to various factors and considerations as previously described, such as but not limited too amortizations, taxes, costs, pricing, present and future values. This data will vary according to the demands of a particular FPPA. Various estimates 54 may be calculated on a regular time interval, such as daily, weekly, monthly and yearly. The estimates 54 may be representative of a particular amount of renewable energy. For example, based on estimates 54, the FPPA may allocate blocks of energy to various customers. The blocks may be purchased by a participating entity, such as but not limited to the utility 50.

When the co-op 32 is first implemented, a portion of the co-op of the whole (CotW) will not have been individually allocated. The unallocated remainder is purchased by an entity or entities pursuant to an FPPA in an allotment that will vary in physical size and electrical power as new, increased, decreased, and liquidated positions are incorporated. This unknown power production will be the remainder that the entity or entities must purchase up to 100% of the gross CotW output over a predetermined period of time.

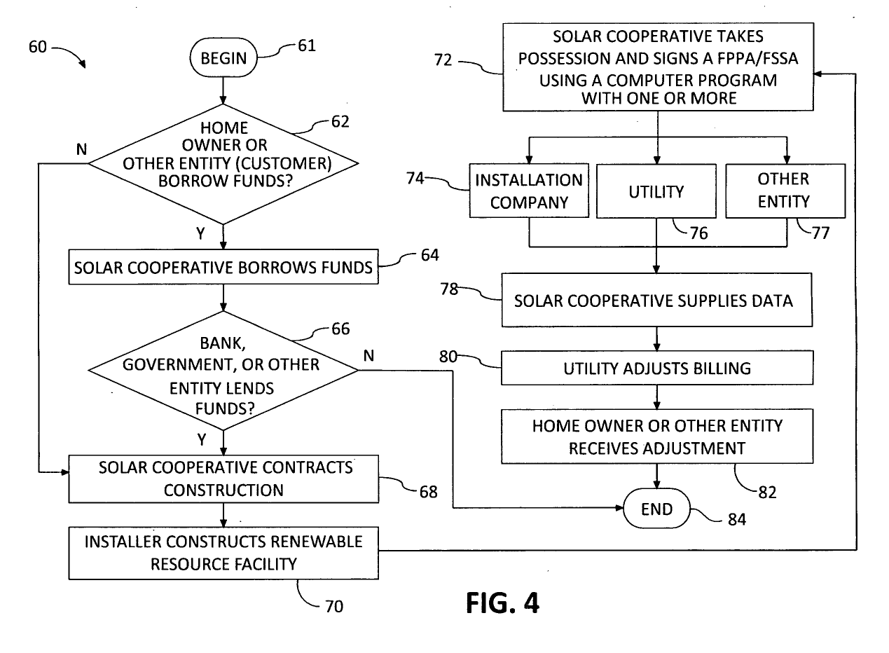

Turning now to FIG. 4, a flow chart diagram of an exemplary method 60 for providing renewable energy to a number of customers including use of a FPPA is depicted. Method 60 begins (step 61) by querying whether the participating entity, such as a homeowner/customer is to borrow funds to finance the renewable energy infrastructure (step 62). If yes, the co-op acts as a vehicle for the customer to do so using economies of scale as the skilled artisan will appreciate (step 64), by negotiating financing with a financing institution such as a bank or governmental body. If this is not possible, the method 60 ends (step 84), however the method 60 assumes that the co-op is able to procure financing (step 66), and the financing institution lends funds to the co-op. The co-op then contracts for construction of the renewable energy infrastructure with an entity such as an installer (step 68). Returning to step 62, if the homeowner wishes to make an up-front payment, the method moves again to step 68, where the co-op arranges for construction.

As a next step, the installer constructs the renewable energy resource facility (step 70). The co-op then takes possession of the infrastructure (step 72). The co-op then executes an FSSA/FPPA electronically with at least one of the installer (step 74), the electrical utility (step 76), and another entity such as a municipality (step 77). The co-op then supplies data (such as estimate data relating to a particular customer as an owner/member of the co-op) pursuant to the FSSA (step 78). Also, pursuant to the FSSA, the utility adjusts billing for the particular customer (step 80). The homeowner then receives the adjusted bill (step 82). The method 60 then ends (step 84).

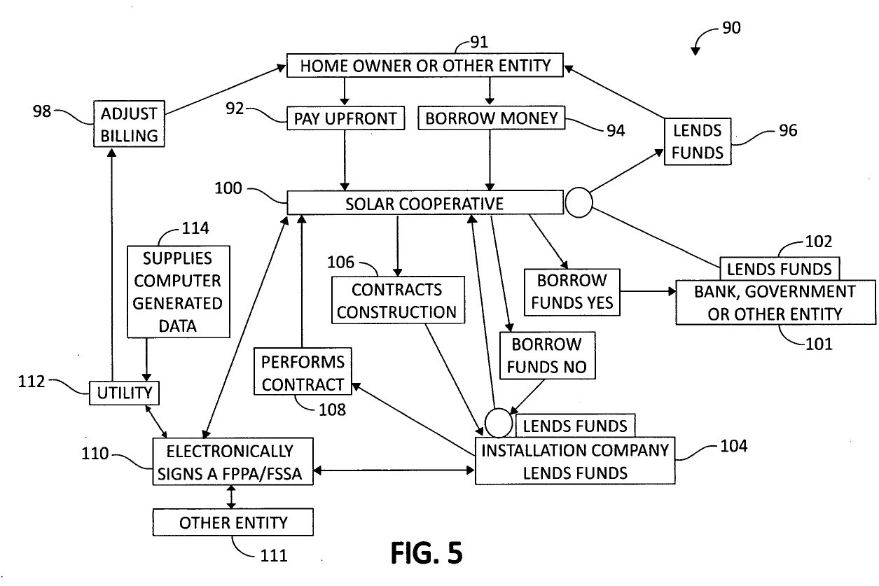

Reference is now made to FIG. 5 wherein a block flow diagram 90 of exemplary relationships between various entities making use of a FPPA to deliver renewable energy is depicted. These entities again include a homeowner (member/owner) or other entity (such as a business organization) 91 represented by the co-op 100, the co-op 100 itself, the financing institution (again such as a bank, governmental body or other entity) 101, an electrical utility 112, an installation company 104, and another entity 111 such as a municipality. As is shown, various relationships are maintained between each participating entity. The owner/member either pays upfront 92 or borrows money 94 for the renewable energy infrastructure as is facilitated by the co-op by lending funds 96. The co-op may borrow funds from the financing institution, which may lend funds 102. The co-op may borrow funds from the installation company 104.

Here as before, the co-op negotiates a FSSA/FPPA 110 as between the electrical utility, the installation company and/or any other entities to purchase remainder/unallocated power. The co-op negotiates installation and/or maintenance (contracts construction 106) of the renewable energy infrastructure with the installation company, which then may perform under the installation/maintenance contract 108, or the maintenance 108 portion may be farmed out to a third party. Pursuant to the FSSA/FPPA, the utility is supplied estimate and related data 114, and the utility adjusts the billing 98 to the homeowner/member/owner accordingly.

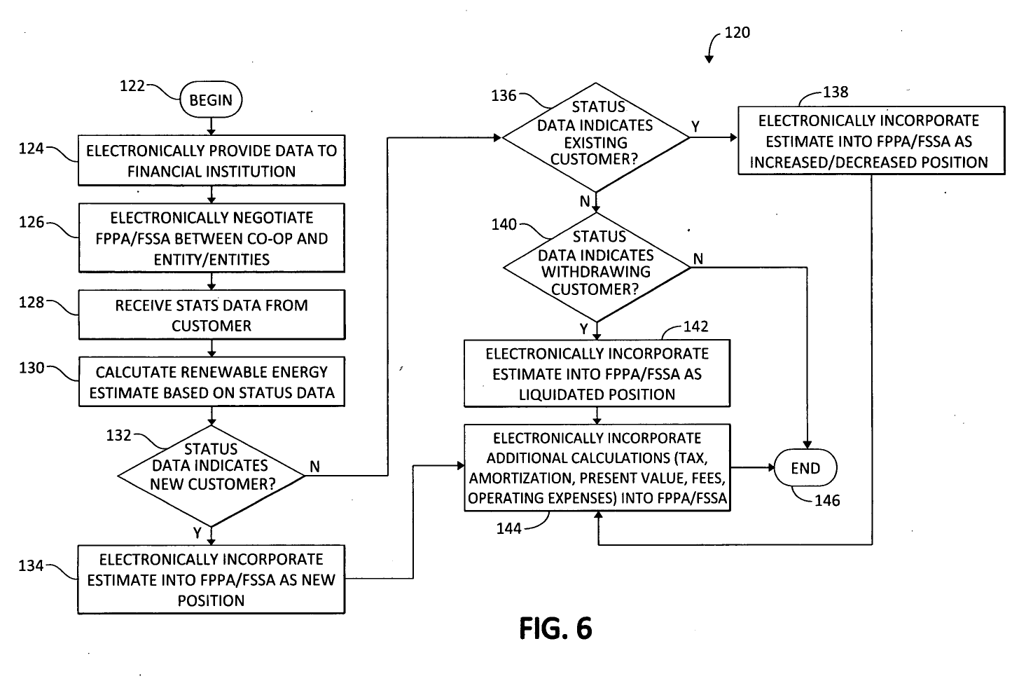

Turning now to FIG. 6 a flow chart diagram of an additional exemplary method 120 for providing renewable energy to a number of customers including use of a FPPA is depicted. As one skilled in the art will appreciate, various steps in the method 120 may be implemented in differing ways to suit a particular application. In addition, the described methods may be implemented by various means, such as hardware, software, firmware, or a combination thereof operational on or otherwise associated with the storage environment. For example, the method may be implemented, partially or wholly, as a computer program product including a computer-readable storage medium having computer-readable program code portions stored therein. The computer-readable storage medium may include disk drives, flash memory, digital versatile disks (DVDs), compact disks (CDs), and other types of storage mediums.

Method 120 begins (step 122) by electronically providing data to one or more financial institutions (step 124) in reference to one or more owner/members of the co-op. Financing is procured and infrastructure is provided as described previously. The FPPA is then electronically negotiated between the co-op and participating entities (step 126), and the co-op begins to operate under the FPPA. The co-op then receives status data from a customer/member/owner (step 128). The status data relates to the status of the customer in the co-op. One or more calculations based on the status data are performed to generate the renewable energy estimates as previously described (step 130).

If the status data indicates that the customer is newly enrolled in the co-op (step 132), then the estimate data is electronically incorporated into the FSSA as a new position (step 134), and the FSSA contracts accordingly as the remainder/unallocated portion is reduced. If the status data indicates that the customer is existing (step 136), then the estimate data is electronically incorporated into the FSSA as an increased or decreased position (step 138), and the FSSA contracts or expands respectively as the remainder portion is decreased or increased, respectively. If the status data indicates a customer that is withdrawing from the co-op, then the estimate data is electronically incorporated into the FSSA as a liquidated position (step 142), and the FSSA expands accordingly as the remainder portion is increased. Additional calculations as previously described pursuant to tax, loan, positions, costs, and other considerations may also be made and incorporated into the FSSA (step 144). The method 120 then ends (step 146).

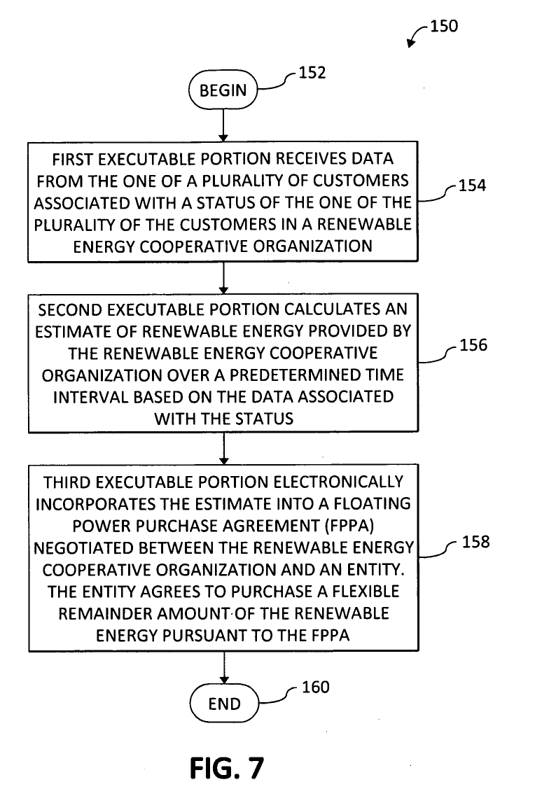

Turning now to FIG. 7, a flow chart diagram of an exemplary method 150 for providing renewable energy to a number of customers including use of a FPPA as embodied in a computer program product is depicted. Method 150 begins (step 152), with a first executable portion receiving data from one of a plurality of customers associated with a status of the one of the plurality of customers in a renewable energy cooperative organization (step 154). A second executable portion calculates an estimate of renewable energy provided by the renewable energy cooperative organization over a predetermined time interval based on the data associated with the status (step 156). Finally, a third executable portion electronically incorporates the estimate into a floating power purchase agreement (FPPA) negotiated between the renewable energy cooperative organization and an entity. The entity agrees to purchase a flexible remainder amount of the renewable energy pursuant to the FPPA 158.

Some of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, as electronic signals on a system or network.

While one or more embodiments of the present invention have been illustrated in detail, the skilled artisan will appreciate that modifications and adaptations to those embodiments may be made without departing from the scope of the present invention as set forth in the following claims.

What is claimed is:

1. A method for providing renewable energy for the benefit of a plurality of customers, said providing incorporating calculations performed by at least one processor of a data processing computer environment, the method comprising:
calculating an estimate of renewable energy provided by a renewable energy cooperative organization over a predetermined time interval based on data associated with a status of one of the plurality of customers in the renewable energy cooperative organization; and
electronically incorporating the estimate into a floating power purchase agreement (FPPA) negotiated between the renewable energy cooperative organization and an entity, the entity agreeing to purchase a flexible remainder amount of the renewable energy pursuant to the FPPA.

2. The method of claim 1, further including receiving the data from the one of the plurality of customers associated with the status of the one of the plurality of customers in the renewable energy cooperative organization.

3. The method of claim 1, wherein the calculating the estimate of renewable energy includes calculating an estimate of solar energy provided by a solar energy cooperative organization, and the electronically incorporating the estimate into the FPPA includes electronically incorporating the estimate into a floating solar service agreement (FSSA) negotiated between the solar energy cooperative organization and the entity.

4. The method of claim 2, wherein the receiving the data from the one of the plurality of customers associated with the status includes receiving enrollment data of a new customer of the renewable energy cooperative organization, and the estimate of the renewable energy is calculated as a new position of the FPPA; wherein the new position is accommodated by the FPPA, fulfilling at least a portion of the FPPA previously unallocated to the plurality of customers in the renewable energy cooperative organization.

5. The method of claim 2, wherein the receiving the data from the one of the plurality of customers associated with the status includes receiving data from an existing customer of the renewable energy cooperative organization, and the estimate of the renewable energy is calculated as one of an increased and a decreased position of the FPPA; wherein the one of the increased and the decreased position is accommodated by the FPPA, the increased position fulfilling a previously unallocated portion of the FPPA and the decreased position providing for an additional allocation to be subsequently fulfilled pursuant to one of a new and an increased position of an additional customer.

6. The method of claim 2, wherein the receiving the data from the one of the plurality of customers associated with the status includes receiving data from a withdrawing customer of the renewable energy cooperative organization, and the estimate of the renewable energy is calculated as a liquidated position of the FPPA; wherein the liquidated position is accommodated by the FPPA, the liquidated position providing for an additional allocation to be subsequently fulfilled pursuant to one of a new and an increased position of an additional customer.

7. The method of claim 1, further including electronically negotiating the FPPA between the renewable energy cooperative organization and the entity by the at least one processor of the data processing computer environment.

8. The method of claim 7, wherein the electronically negotiating the FPPA between the renewable energy cooperative organization and the entity includes electronically negotiating the FPPA between the renewable energy cooperative organization and at least one of a utility and an installer; wherein pursuant to the FPPA the installer agrees to perform one of provide and reassign renewable energy infrastructure according to the estimate of renewable energy.

9. The method of claim 1, wherein at least one of the receiving the data, the calculating the estimate of renewable energy, and the electronically incorporating the estimate is embodied in a computer program product having computer-readable program code portions executable thereon.

10. The method of claim 1, further including electronically providing at least one of the data and the estimate to a financial institution to facilitate financing of renewable energy infrastructure.

11. The method of claim 1, further including electronically incorporating calculations pursuant to one of a net metering mechanism, an amortization, a tax, an investment tax credit (ITC), an insurance cost, a maintenance cost, a labor cost, a surcharge, a delivery charge, and a fee into the FPPA.

12. A system for providing renewable energy for the benefit of a plurality of customers, comprising:
a processor operable in a data processing computer environment, wherein the processor is adapted for:
calculating an estimate of renewable energy provided by a renewable energy cooperative organization over a predetermined time interval based on data associated with a status of the one of the plurality of customers in the renewable energy cooperative organization, and
electronically incorporating the estimate into a floating power purchase agreement (FPPA) negotiated between the renewable energy cooperative organization and an entity, the entity agreeing to purchase a flexible remainder amount of the renewable energy pursuant to the FPPA.

13. The system of claim 12, wherein the processor is further adapted for calculating an estimate of solar energy provided by a solar energy cooperative organization, electronically incorporating the estimate of solar energy into a floating solar service agreement (FSSA) negotiated between the solar energy cooperative organization and the entity.

14. The system of claim 12, wherein the processor is further adapted for receiving enrollment data of a new customer of the renewable energy cooperative organization, and the estimate of the renewable energy is calculated as a new position of the FPPA; wherein the new position is accommodated by the FPPA, fulfilling at least a portion of the FPPA previously unallocated to the plurality of customers in the renewable energy cooperative organization.

15. The system of claim 12, wherein the processor is further adapted for receiving data from an existing customer of the renewable energy cooperative organization, and the estimate of the renewable energy is calculated as one of an increased and a decreased position of the FPPA; wherein the one of the increased and the decreased position is accommodated by the FPPA, the increased position fulfilling a previously unallocated portion of the FPPA and the decreased position providing for an additional allocation to be subsequently fulfilled pursuant to one of a new and an increased position of an additional customer.

16. The system of claim 12, wherein the processor is further adapted for receiving data from a withdrawing customer of the renewable energy cooperative organization, and the estimate of the renewable energy is calculated as a liquidated position of the FPPA; wherein the liquidated position is accommodated by the FPPA, the liquidated position providing for an additional allocation to be subsequently fulfilled pursuant to one of a new and an increased position of an additional customer.

17. The system of claim 12, wherein:
the entity includes at least one of a utility and an installer; wherein pursuant to the FPPA the installer agrees to perform one of provide and reassign renewable energy infrastructure according to the data, and
the processor is further adapted for providing at least one of the data and the estimate to a financial institution to facilitate financing of renewable energy infrastructure.

18. The system of claim 12, wherein the processor is further adapted for electronically incorporating calculations pursuant to one of a net metering mechanism, an amortization, a tax, an investment tax credit (ITC), an insurance cost, a maintenance cost, a labor cost, a surcharge, a delivery charge, and a fee into the FPPA.

19. A business method for facilitating delivery of renewable energy to a plurality of customers, comprising:
implementing a floating power purchase agreement (FPPA) negotiated between a renewable energy cooperative organization and a participating entity, wherein the FPPA flexibly allocates remainder portions of the renewable energy underwritten by each of the plurality of customers based on a status determination of the plurality of customers in the renewable energy cooperative organization.

20. The business method of claim 19, wherein implementing a FPPA includes implementing a floating solar service agreement (FSSA) negotiated between a solar energy cooperative organization and the participating entity, wherein the FSSA flexibly allocates a portion of solar energy underwritten by each of the plurality of customers based on the status determination of the plurality of customers in the renewable energy cooperative organization.

21. The business method of claim 19, wherein the FPPA flexibly allocates a new customer participating in the renewable energy cooperative organization as a new position in the FPPA, an existing customer having a status change reflective of one of an increased and a decreased position in the FPPA, and a withdrawing customer as a liquidated position in the FPPA; wherein the FPPA contracts pursuant to one of the new and the increased position, and expands pursuant to one of the decreased position and the liquidated position.

22. The business method of claim 19, wherein the participating is at least one of an installer and a utility, and the implementing the FPPA includes negotiating the FPPA as between the at least one of the installer and the utility.

23. The business method of claim 22, wherein the implementing the FPPA includes obtaining funds for constructing renewable energy infrastructure pursuant to an installation agreement as between at least one of a financing institution, government body, and the installer.

24. The business method of claim 19, further including calculating one portion of the renewable energy underwritten by one of the plurality of customers as a renewable energy calculation provided to the participating entity, wherein the participating entity incorporates the renewable energy calculation into a billing determination.

25. The business method of claim 19, further including forming the renewable energy cooperative organization for purposes of the implementing the FPPA as between the renewable energy cooperative organization and the participating entity.
